(19) United States
(12) Patent Application Publication
(10) Pub. No.: US 2006/0171355 A1
(43) Pub. Date: Aug. 3, 2006

(54) Method and system for transmitting/receiving session non-interest indication information of UE in a multimedia broadcast/multicast service system

(75) Inventors: No-Jun Kwak, Seoul (KR); Himke Van Der Velde, Staines (GB); Kook-Heui Lee, Yongin-si (KR); Kyeong-In Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/340,839

(22) Filed: Jan. 27, 2006

(30) Foreign Application Priority Data
Jan. 28, 2005 (KR) 10-2005-0008239
Feb. 2, 2005 (KR) 10-2005-0009750

(51) Int. Cl. H04Q 7/00

(52) U.S. Cl. 370/329

(57) ABSTRACT

An apparatus and method are provided for transmitting session non-interest indication information for a Multimedia Broadcast/Multicast Service (MBMS) service of a user equipment (UE) in an MBMS system. A serving radio network controller (SRNC) determines whether the UE desires to receive a current session for an MBMS service joined by the UE. The SRNC transmits session non-interest indication information for the MBMS service of the UE to a drift radio network controller (DRNC) according to the determination result. The DRNC includes the UE in an MBMS context for the MBMS service and determines whether to exclude the UE from counting for the MBMS service according to the session non-interest indication information of the UE.

### CROSS-REFERENCE TO RELATED APPLICATIONS

This application claims the benefit under 35 U.S.C. §119(a) of Korean Patent Application No. 10-2005-0008239 entitled “Method and System for Transmitting/Receiving Session Non-Interest Indication Information of UE in a Multimedia Broadcast/Multicast Service System”, filed in the Korean Intellectual Property Office on Jan. 28, 2005, and Korean Patent Application No. 10-2005-0009750 entitled “Method and System for Transmitting/Receiving Session Non-Interest Indication Information of UE in a Multimedia Broadcast/Multicast Service System”, filed in the Korean Intellectual Property Office on Feb. 2, 2005, the entire disclosure of both of which are hereby incorporated by reference.

### BACKGROUND OF THE INVENTION

1. Field of the Invention

The present invention relates generally to a Multimedia Broadcast/Multicast Service (MBMS) service. In particular, the present invention relates to a method in which, upon detecting movement of a user equipment (UE) to a new drift radio network controller (DRNC) during a session, a serving radio network controller (SRNC) informs the DRNC whether the UE has received the session.

2. Description of the Related Art

With the recent development of communication technology, service provided in a mobile communication system employing a Wideband Code Division Multiple Access (WCDMA) scheme is evolving into Multimedia Broadcast/Communication that can support not only the conventional voice service, but also a packet service and a multimedia service used for high-capacity data transmission. In order to support the Multimedia Broadcast/Communication, discussions are now underway for MBMS service that provides a service from one or a plurality of multimedia data sources to a plurality of UEs.

The term “MBMS service” as used herein, refers to a service that transmits the same multimedia data to a plurality of recipients via a wireless network. The MBMS service can save radio transmission resources by allowing a plurality of recipients to share one radio channel. The MBMS service supports transmission of multimedia data such as real-time image and voice, still image, and text, and can simultaneously provide voice data and image data according to multimedia transmission. For that purpose, the MBMS service requires a large amount of transmission resources.

FIG. 1 is a diagram schematically illustrating nodes that participate in providing MBMS service in a general mobile communication network. It is assumed herein, for example, that the MBMS service is applied to a 3^{rd} Generation Partnership Project (3GPP) system, which is the standard for the 3^{rd} generation asynchronous mobile communication system based on Global System for Mobile Communications (GSM) and General Packet Radio Services (GPRS).

Referring to FIG. 1, user equipments (UEs) 161, 162, 163, 171 and 172 each denote a terminal device or a subscriber that can receive MBMS service, and a cell #1 160 and a cell #2 170, which are base stations, i.e., Node Bs, for wirelessly transmitting MBMS-related data to subscribers, each represent a physical or logical service area controlled by the corresponding Node B. A radio network controller (RNC) 140 controls the cells 160 and 170, selectively transmits multimedia data to a particular cell, and controls wireless channels established to provide MBMS services. Connections between the RNC 140 and the UEs 161, 162, 163, 171 and 172 are made by a Radio Resource Control (RRC) interface.

The RNC 140 is connected to a packet switched or packet service (PS) network such as the Internet, by a Serving GPRS Support Node (SGSN) 130. Communication between the RNC 140 and the PS network is achieved by packet switched (PS) signaling. In particular, a connection between the RNC 140 and the SGSN 130 is called an Iu-PS interface. The SGSN 130 controls MBMS-related service for each subscriber. The typical exemplary function controlled by the SGSN 130 includes a function of managing service accounting-related data for each subscriber and a function of selectively transmitting to a particular RNC 140.

A transit network 120 provides a communication path between a Broadcast Multicast Service Center (BM-SC) 110 and the SGSN 130, and can be connected to the external network via a Gateway GPRS Support Node (GGSN, not shown). The BM-SC 110, a source of MBMS data, takes charge of scheduling the MBMS data.

The RNC 140 is connected to a circuit switched (CS) network by a Mobile Switching Center (MSC) 150. The CS network denotes a connection-based voice-oriented legacy communication network. Communication between the RNC 140 and the MSC 150 is achieved by circuit switched (CS) signaling. In particular, a connection between the RNC 140 and the MSC 150 is called an Iu-SC interface.

An MBMS data stream generated from the BM-SC 110 arrives at the UEs 161, 162, 163, 171 and 172 via the transit network 120, the SGSN 130, the RNC 140, and the Node Bs or cells 160 and 170.

Although not illustrated in FIG. 1, in yet other configurations a plurality of SGSNs can be provided for one MBMS service, and a plurality of RNCs can be provided for each SGSN. Each of the SGSNs perform selective data transmission to a plurality of RNCs, and each of the RNCs perform selective data transmission to a plurality of cells. To this end, the SGSN and the RNC store lists of their lower nodes (for example, a list of RNCs and a list of cells, respectively) to which they should deliver data streams, and perform selective MBMS data transmission only to the nodes included in the lists.

FIG. 2 is a diagram illustrating a situation in which an SRNC and a DRNC are different for a particular UE. That is, FIG. 2 illustrates a situation in which, although an RNC1 302 manages communications of UEs 311 through 314 in a mobile communication system, the UEs 311 through 314, as they are physically located, actually use the radio resources managed by an RNC2 303.

Referring to FIG. 2, a core network (CN) node 301 collectively represents such nodes as the BM-SC, transit network, MSC and SGSN. The RNC1 302 and the RNC2 303 are both connected to the CN node 301. A wire path 331 for connecting the CN node 301 to the RNCs 302 and 303 is called an Iu interface, and a wire path 332 for connecting the RNC1 302 to the RNC2 303 is called an Iur interface. A Node B that serves to directly manage one or more cells and which is located between the RNC2 303 and the UEs 311 through 314, is omitted herein. The RNC2 303 is called a Drift RNC (DRNC) for directly managing the one or more cells in which the UEs 311 through 314 are located, and the RNC1 302 is called a Serving RNC (SRNC) for controlling communications of the UEs 311 through 314.

FIG. 3 is a diagram illustrating an MBMS service procedure between a UE and a network. In FIG. 3, a BM-SC 206 communicates with a UE 202 via an RNC 204, and the RNC 204 communicates with the BM-SC 206 via an SGSN (not shown). Although one RNC 204 and one UE 202 are illustrated in FIG. 3, embodiments of the present invention are not limited thereto and the same procedure can also be applied to a plurality of UEs desiring to receive the MBMS service and a plurality of RNCs.

Referring to FIG. 3, in a Subscription step 210, a user, i.e., the UE 202, desiring to receive an MBMS service, registers itself in the BM-SC 206 which is a service provider. In this step, the BM-SC 206 exchanges basic information related to accounting and service reception with the UE 202.

In an Announcement step 220, UEs analyze basic information on the MBMS service. For example, the UEs find MBMS identifiers (IDs) used for distinguishing MBMS services available in the BM-SC 206, service start time, and duration. The MBMS ID includes a multicast address and an access point name (APN). In the Announcement step 220, the nodes interposed between the BM-SC 206 and the UE 202, i.e., the RNC 204, the SGSN, and the transit network, recognize the UE 202 and the nodes connected to the UE 202. For example, the SGSN analyzes a list of the UEs desiring to receive the MBMS service and a list of RNCs in which the UEs are located, and based on the lists, transmits MBMS data only to the RNCs where the UEs are located.

After acquiring the basic information on the MBMS service, the UE 202 performs a Joining step 230 to receive the desired MBMS service data. The UE 202 provides the BM-SC 206 with at least one desired MBMS ID among the MBMS IDs acquired through the Announcement step 220.

A Notification step 240 pages the UE 202 to inform that the MBMS service requested by the UE 202 will start soon. That is, the Notification step 240 performs group paging on a plurality of UEs joining in the MBMS service.

A Radio Resource Allocation step 250 allocates radio resources between the UE 202 and the RNC 204 to provide the MBMS service, and provides the corresponding information to the related nodes. The RNC 204 can select one of point-to-multipoint (PTM) and point-to-point (PTP) schemes based on information on the number of UEs belonging to each of its cells and a radio resource management (RRM) function.

In a Data Transfer step 260, actual MBMS data is transferred to the UE 202 via the RNC 204. If there is a need to change information on the MBMS service, for example, a ciphering key, the RNC 204 provides a new ciphering key to all UEs receiving the MBMS service.

When the MBMS service ends (closes), a Radio Resource Release step 270 releases the allocated radio resources and informs the UE 202 that the MBMS radio resources were released. Although not illustrated, in the course of receiving the MBMS service in step 250, the UE 202 may spontaneously request interruption of the MBMS service and stop receipt of the MBMS service.

For each MBMS service, the RNC manages an MBMS context in which information on the UEs desiring to receive the MBMS service is stored. One MBMS service includes several sessions. The MBMS context is managed until the MBMS service ends or the RNC has no UE receiving the MBMS service, regardless of start and end of the session, and when a new session starts, determining whether to transmit the session using the PTP scheme or the PTM scheme is made taking into consideration the number of UEs included in the MBMS context. A process of counting the number of UEs is called a Counting process.

FIG. 4 is a diagram illustrating a situation in which the same MBMS service is transmitted in a cell #1 401 and a cell #2 402. As illustrated, the same session can repeatedly appear for the MBMS service, and this is called a ‘repeated session’. In the repeated session situation, if a UE has already received the same session, an RNC excludes the UE from a Counting process, thereby increasing efficiency of radio resources.

In this repeated transmission situation, although an SRNC is aware that the UE has already received a session, a DRNC includes the UE in the Counting process when the UE has moved to another cell managed by the DRNC, as shown by reference numeral 450. In this case, due to the UE actually not receiving the session, an MBMS service in which the PTP scheme is preferred, may be set for the PTM scheme, which wastes radio resources.

Accordingly, a need exists for a method and apparatus for detecting movement of a user equipment (UE) to a new drift radio network controller (DRNC) during a session, and informing the DRNC whether the UE has received the session.

### SUMMARY OF THE INVENTION

It is, therefore, an object of the present invention to substantially solve the above and other problems, and provide a method and apparatus in which when a UE moves to a target cell managed by a DRNC, an SRNC determines whether the UE has actually received a session and provides the resultant information to the DRNC.

It is another object of the present invention to provide a method and apparatus in which upon receiving, from an SRNC, information indicating whether a UE has actually received a session, a DRNC excludes the UE from a counting process to efficiently use radio resources.

According to one aspect of embodiments of the present invention, a method for transmitting session non-interest indication information for a Multimedia Broadcast/Multicast Service (MBMS) service of a user equipment (UE) in an MBMS system is provided. The method comprises the steps of determining by a serving radio network controller (SRNC) whether the UE desires to receive a current session for an MBMS service joined by the UE, transmitting, by the SRNC, session non-interest indication information for the MBMS service of the UE to a drift radio network controller (DRNC) according to the determination result, and including, by the DRNC, the UE in an MBMS context for the MBMS service and determining whether to exclude the UE from counting for the MBMS service according to the session non-interest indication information of the UE.

According to another aspect of embodiments of the present invention, a Multimedia Broadcast/Multicast Service (MBMS) system for providing an MBMS service to a user equipment (UE) is provided. The MBMS system comprises a serving radio network controller (SRNC) for generating session non-interest indication information of the UE indicating whether the UE desires to receive a current session for the MSMS service joined by the UE, and a drift radio network controller (DRNC) for receiving the session non-interest indication information of the UE from the SRNC and determining whether to exclude the UE from counting for the MBMS service according to the session non-interest indication information.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 is a diagram illustrating a general network configuration for an MBMS service;

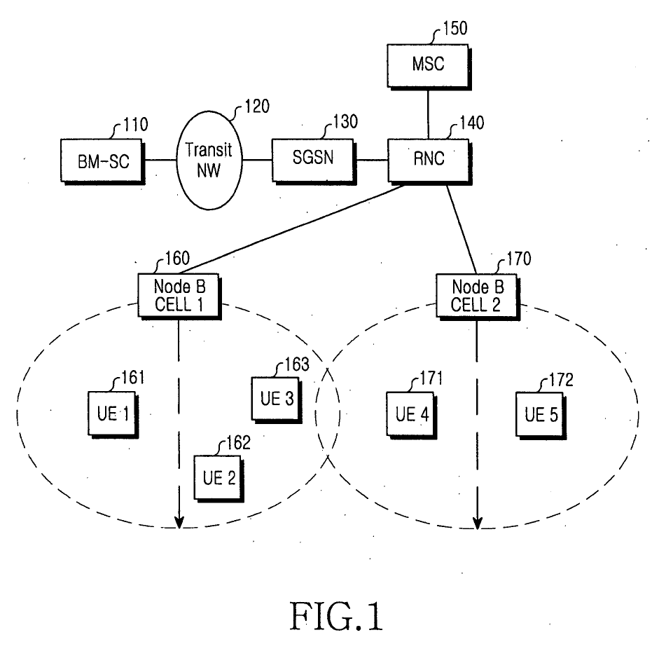

FIG. 2 is a diagram illustrating a situation in which an SRNC and a DRNC are different for a particular UE;

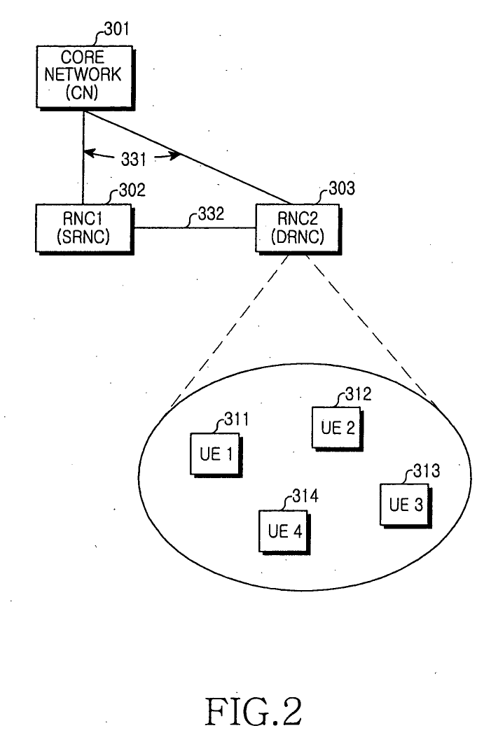

FIG. 3 is a diagram illustrating a general MBMS service procedure between a UE and a network;

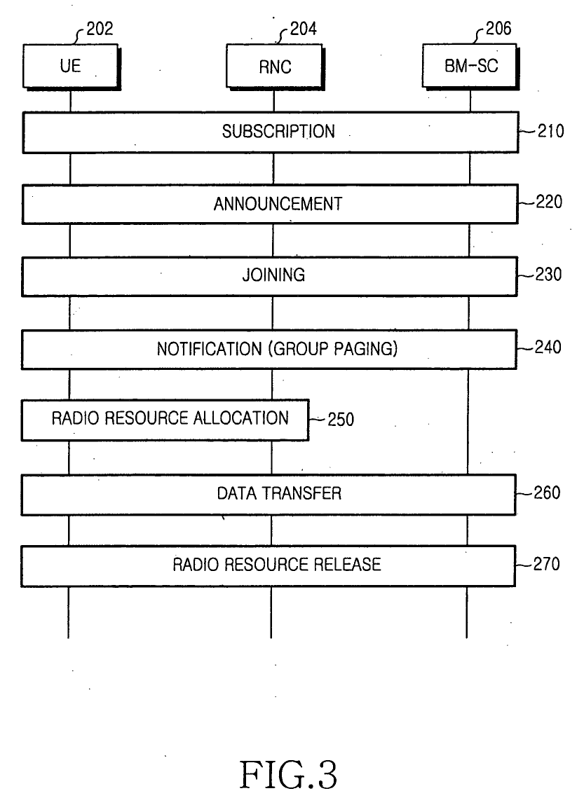

FIG. 4 is a diagram illustrating a situation in which the same MBMS service is transmitted in two adjacent cells;

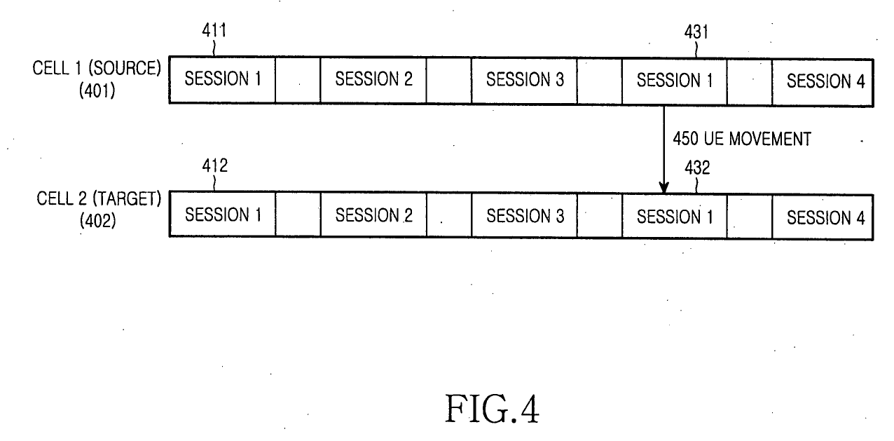

FIG. 5 is a signaling diagram between RNCs and a UE in a state other than a CELL_DCH state according to a first exemplary embodiment of the present invention;

FIG. 6 is a signaling diagram between RNCs and a UE in a state other than a CELL_DCH state according to a second exemplary embodiment of the present invention;

FIG. 7 is a flowchart illustrating an exemplary operation of an SRNC according to the signaling diagram of FIG. 5;

FIG. 8 is a flowchart illustrating an exemplary operation of an SRNC according to the signaling diagram of FIG. 6;

FIG. 9 is a flowchart illustrating an exemplary operation of a DRNC according to the first and second exemplary embodiments of the present invention;

FIG. 10 is a signaling diagram according to a third exemplary embodiment of the present invention;

FIG. 11 is a flowchart illustrating an operation of an SRNC according to the third exemplary embodiment of the present invention; and

FIG. 12 is a flowchart illustrating an operation of a DRNC according to the third exemplary embodiment of the present invention.

Throughout the drawings, like reference numerals will be understood to refer to like parts, components and structures.

### DETAILED DESCRIPTION OF EXEMPLARY EMBODIMENTS

Exemplary embodiments of the present invention will now be described in detail with reference to the annexed drawings. In the following description, a detailed description of known functions and configurations incorporated herein has been omitted for clarity and conciseness.

An aspect of embodiments of the present invention is to provide ‘session interest indication information’ of a UE for a particular MBMS service from an SRNC to a DRNC. Herein, the expression “a UE is uninterested in a particular MBMS service” includes the case where the UE has already received the same session in the repeated transmission situation. In addition, the expression “a UE is interested in a particular MBMS service” includes the case where the UE has never received the session before.

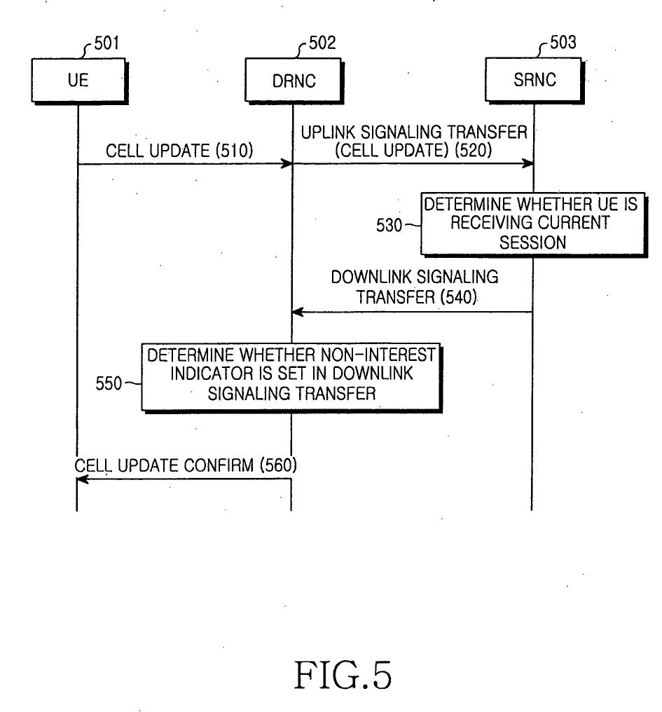

FIG. 5 is a signaling diagram for the case where a UE in a state other than a Cell_Dedicated Channel (CELL_DCH) state, i.e., a UE having no DCH, moves to another cell according to an exemplary embodiment of the present invention.

Referring to FIG. 5, upon detecting a high reception sensitivity of a neighbor cell, a UE 501 transmits a Cell Update message to a DRNC 502 that controls the neighbor cell in step 510. The DRNC 502 forwards the Cell Update message to an SRNC 503 through an Uplink Signaling Transfer message in step 520.

Upon receiving the Cell Update message, the SRNC 503 determines in step 530, whether the MBMS service joined by the UE 501 is currently in progress, and determines whether the UE 501 is receiving the current session of the MBMS service if the MBMS service is in progress.

If it is determined that the UE 501 is receiving the current session, the SRNC 503 no-sets (or does not set) a non-interest indicator indicating that the UE 501 is receiving the current session, and includes the no-set non-interest indicator in a Downlink Signaling Transfer (DST) message along with a service ID of the MBMS service. Herein, no-setting the non-interest indicator refers to a method of not including the non-interest indicator in the Downlink Signaling Transfer message or setting the non-interest indicator to N (No).

If the UE 501, although it joined the service, is not receiving the current session, the SRNC 503 sets the non-interest indicator and includes it in the Downlink Signaling Transfer message along with the service ID. Herein, setting the non-interest indicator refers to a method of setting the non-interest indicator to Y (Yes).

In FIG. 5, if the UE 501 is interested in an MBMS service S1 and is uninterested in an MBMS service S2, the SRNC 503 no-sets the non-interest indicator for the S1 and sets the non-interest indicator for the S2 in step 530. The SRNC 503 transmits the Downlink Signaling Transfer message to the DRNC 502 in step 540.

The DRNC 502 determines in step 550 whether a non-interest indicator is set in the Downlink Signaling Transfer message for each individual MBMS service. If it is determined that the non-interest indicator is set, the DRNC 502 includes the UE 501 in an MBMS context and excludes the UE 501 from counting. However, if it is determined that the non-interest indicator is not set and only the service ID is included in the Downlink Signaling Transfer message, the DRNC 502 includes the UE 501 in the MBMS context and also includes the UE 501 in the counting for determining a transfer mode of the MBMS service. For reference, as used herein a process of including a UE in an MBMS context is called an “attach” process.

The DRNC 502 transmits a Cell Update Confirm message to the UE 501 in step 560. Alternatively, the DRNC 502 may transmit the Cell Update Confirm message after transmitting the Uplink Signaling Transfer message.

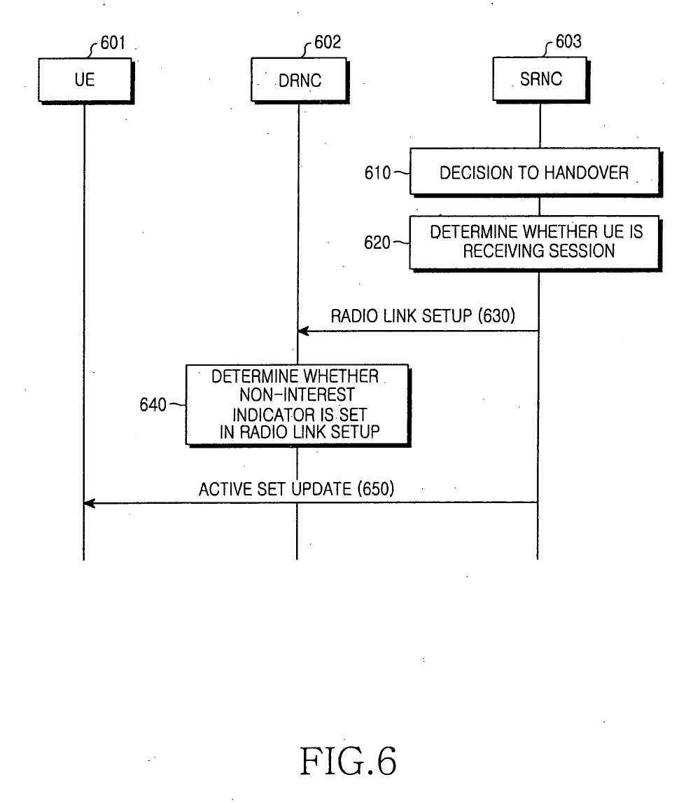

FIG. 6 is a signaling diagram for a case where a UE in a state other than a CELL_DCH state, i.e., a UE having no DCH, is allowed to move to a cell managed by a DRNC according to an exemplary embodiment of the present invention.

Referring to FIG. 6, an SRNC 603 determines whether to allow a UE 601 to move a cell managed by a new DRNC 602 in step 610, and determines in step 620 whether the UE 601 is actually receiving a session for an MBMS service.

If it is determined that the UE 601 is actually receiving the current session, the SRNC 603 no-sets, in step 620, a non-interest indicator indicating that the UE 601 is receiving the current session, and includes the no-set non-interest indicator and a service ID of the MBMS service in a Radio Link Setup message. However, if the UE 601, although it joined the service, is not receiving the current session, the SRNC 603 sets the non-interest indicator and includes it in the Radio Link Setup message along with the service ID.

The SRNC 603 transmits the Radio Link Setup message to the DRNC 602 in step 630.

The DRNC 602 determines in step 640 whether a non-interest indicator is set in the Radio Link Setup message for each individual MBMS service. If the non-interest indicator is set, the DRNC 602 includes the UE 601 in an MBMS context and excludes the UE 601 from counting. However, if it is determined that the non-interest indicator is not set and only the service ID is included in the Radio Link Setup message, the DRNC 602 includes the UE 601 in the MBMS context and also includes the UE 601 in the counting for the MBMS service.

The SRNC 603 transmits in step 650, an Active Set Update message to the UE 601 as a result of step 610, allowing the UE 601 to perform handover.

In FIGS. 5 and 6, the non-interest indicator included the Downlink Signaling Transfer (DST) message or the Radio Link Setup message transmitted from an SRNC to a DRNC has the format shown in Table 1 and Table 2, by way of example, wherein the non-interest indicator indicates whether a UE is receiving a current session.

Table 1 shows a format of a 1-bit indicator used as the non-interest indicator according to a first embodiment of the present invention.

For example, a non-interest indicator=‘1’, (set) indicates that a UE, although it joined an MBMS service, is not receiving a current session. However, a non-interest indicator=‘0’, (no-set) indicates that the UE is receiving the current session. The 1-bit indicator is used on the assumption, for example, that a cell where the UE is initially located and a cell to which the UE intends to move are coincident with each other in terms of session transmission timing, but is not limited thereto.

TABLE 1

| IE/Group | | | IE Type and | Semantics | | Assigned |
|---|---|---|---|---|---|---|
| Name | Presence | Range | Reference | Description | Criticality | Criticality |
| MBMS Bearer | | 0 . . . <maxno | | | GLOBAL | ignore |
| Service List | | of MBMS> | | | | |
| >TMGI | M | | 9.2.1.80 | | | |
| >UE non- | O | | 1 bit | If included, UE | | |
| interest | | | | is uninterested | | |
| indicator | | | | in the current | | |
| | | | | session | | |

Table 2 shows a method of including a session ID of a current session in session setup indication information of a UE and providing a DRNC with a non-interest indicator indicating whether the UE is interested in a session corresponding to the session ID according to a second embodiment of the present invention.

This method can be used even when session transmission timing is inconsistent between cells, but is not limited thereto. Using session ID inclusion indication as the non-interest indicator, this method can allow a DRNC to determine whether a UE has received a corresponding session.

TABLE 2

| IE/Group | | | IE Type and | Semantics | | Assigned |
|---|---|---|---|---|---|---|
| Name | Presence | Range | Reference | Description | Criticality | Criticality |
| Message Type | M | | 9.2.1.40 | | YES | reject |
| Transaction | M | | 9.2.1.59 | | | |
| ID | | | | | | |
| MBMS Bearer | | 1 . . . <maxno | | | | |
| Service List | | of MBMS> | | | | |
| >TMGI | M | | | Service id | YES | reject |
| >Session id | O | | | Current | YES | ignore |
| | | | | session id | | |

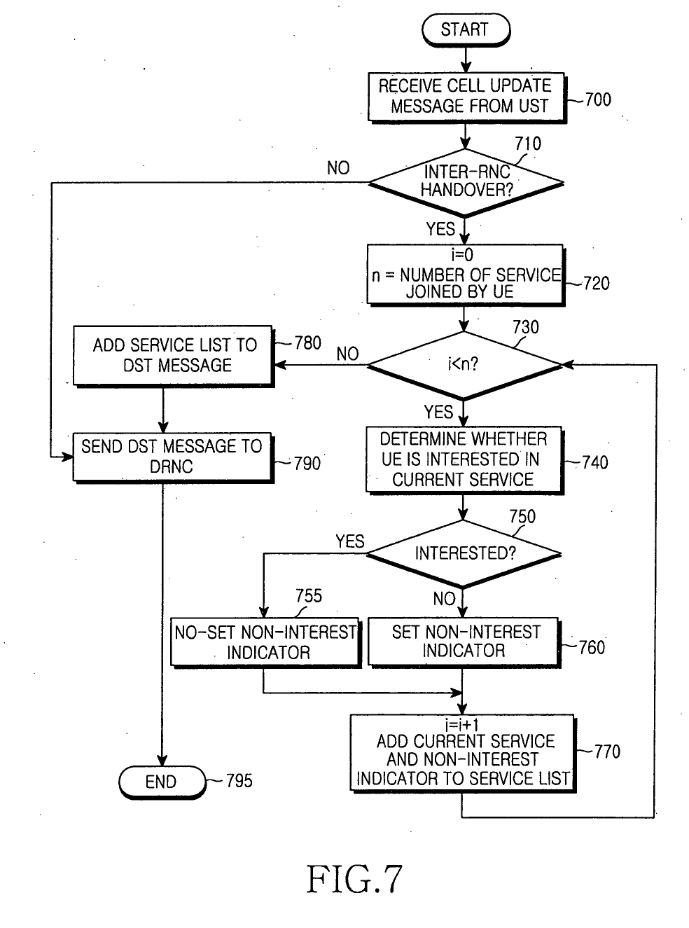

FIG. 7 is a flowchart illustrating an exemplary operation of an SRNC according to the signaling diagram of FIG. 5.

Referring to FIG. 7, an SRNC receives a Cell Update message from an Uplink Signaling Transfer (UST) system in step 700, and determines in step 710 whether the Cell Update message requests an inter-RNC handover.

If it is determined that a handover to a new RNC is requested, the SRNC checks the number, n, of MBMS services joined by a UE and sets an index i to 0, in step 720, and then determines in step 730 whether i<n. If it is determined that i≧n, the SRNC proceeds to step 780. However, if i<n, the SRNC repeatedly performs steps 740 through 770 on all MBMS services joined by the UE.

That is, the SRNC checks in step 740 whether the UE is interested in a current session of an i^{th} MBMS service. If it is determined that the UE is interested in the current session, i.e., if the UE is receiving the current session, the SRNC proceeds to step 755 where it no-sets a non-interest indicator for the i^{th} MBMS service. However, if it is determined that the UE, although it joined in the i^{th} MBMS service, is uninterested in the current session, i.e., if the UE is not receiving the current session, the SRNC sets the non-interest indicator for the i^{th} MBMS service in step 760, and includes a service ID of the i^{th} MBMS service and the non-interest indicator in a service list and increases i by 1 in step 770, and then returns to step 730.

After repeating steps 730 through 770 for all MBMS services joined by the UE, the SRNC includes the service list with the format shown in Table 1 or Table 2 in a DST message in step 780, and transmits the DST message to a DRNC in step 790.

If it is determined in step 710 that handover to a new DRNC is not requested, the SRNC transmits the existing DST message to the DRNC in step 790, and then ends the operation.

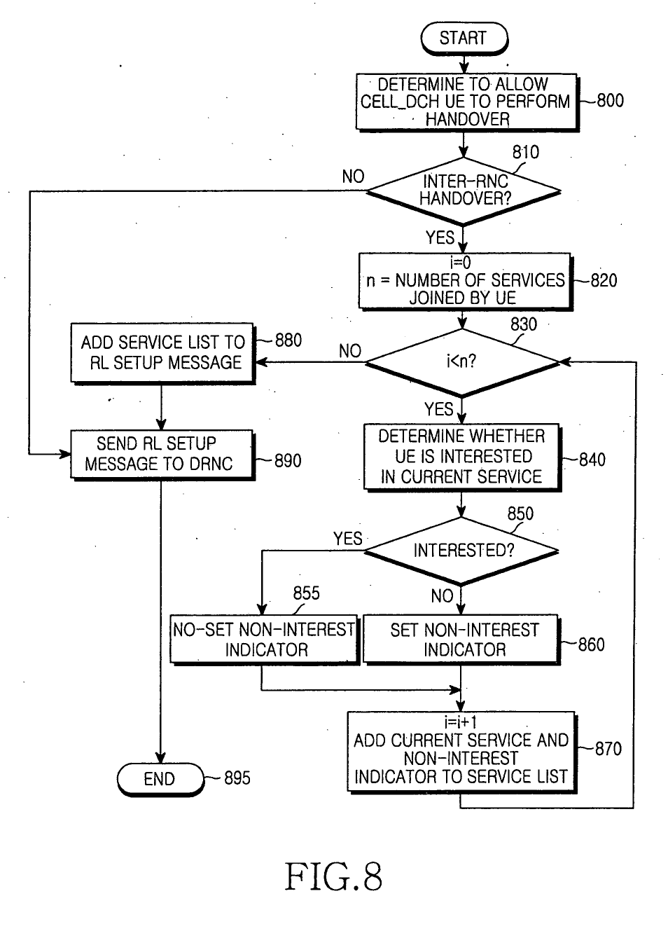

FIG. 8 is a flowchart illustrating an exemplary operation of an SRNC according to the signaling diagram of FIG. 6.

Referring to FIG, 8, an SRNC determines whether to allow a UE in a CELL_DCH state to perform handover in step 800, and determines in step 810 whether there is a need to perform handover to a new DRNC.

If it is determined to perform handover to a new DRNC, the SRNC proceeds to step 820. Otherwise, the SRNC sends the existing Radio Link Setup message to a DRNC in step 890, and then ends the operation.

In step 820, the SRNC checks the number, n, of MBMS services joined by a UE and sets an index i to 0. Thereafter, the SRNC determines in step 830 whether i<n. If it is determined that i≧n, the SRNC proceeds to step 880. However, if i<n, the SRNC repeatedly performs steps 840 through 870 on all MBMS services joined by the UE.

That is, the SRNC checks in step 850 whether the UE is interested in a current session of an i^{th} MBMS service. If it is determined that the UE is interested in the current session, i.e., if the UE is receiving the current session, the SRNC proceeds to step 855 where it no-sets a non-interest indicator for the i^{th} MBMS service.

However, if it is determined that the UE is uninterested in the current session, indicating that the UE, although it joined in the i^{th} MBMS service, is uninterested in the current session, i.e., if the UE is not receiving the current session, the SRNC sets the non-interest indicator for the i^{th} MBMS service in step 860, and includes a service ID of the i^{th} MBMS service and the non-interest indicator in a service list and increases i by 1 in step 870, and then returns to step 830.

After repeating steps 830 through 870 for all MBMS services joined by the UE, the SRNC includes the service list with the format shown in Table 1 or Table 2 in the Radio Link Setup message in step 880, and transmits the Radio Link Setup message to a DRNC in step 890, completing the operation.

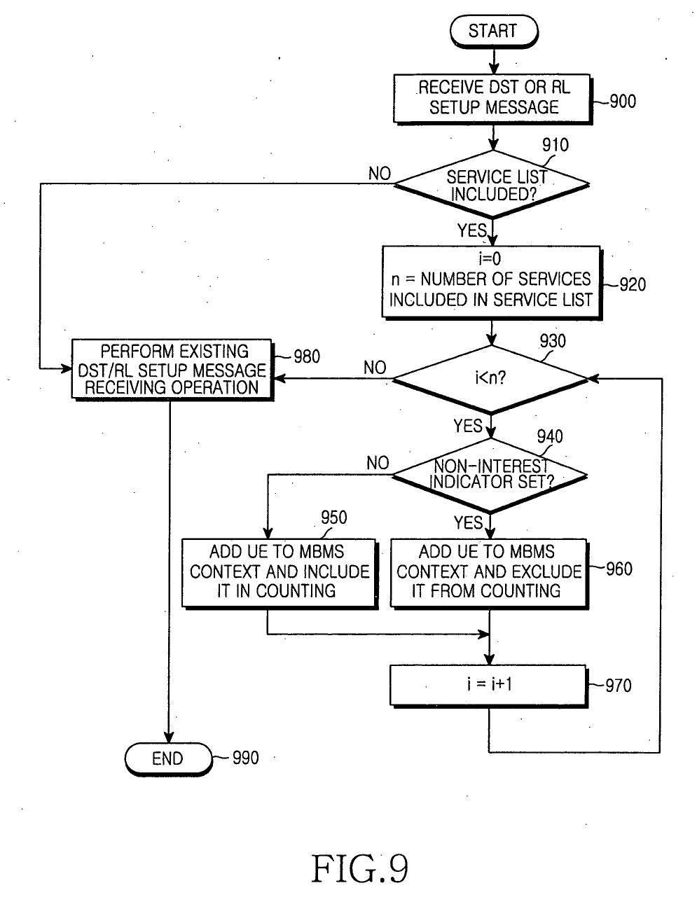

FIG. 9 is a flowchart illustrating an exemplary operation of a DRNC according to the first and second embodiments of the present invention.

Referring to FIG. 9, a DRNC receives a Downlink Signaling Transfer (DST) message or a Radio Link Setup message for a particular UE from an SRNC in step 900, and determines in step 910 whether the received Downlink Signaling Transfer message or Radio Link Setup message includes therein a service list shown in Table 1 or Table 2. If it is determined that the service list is not included, the DRNC performs the previously defined operation of the DRNC in step 980.

However, if it is determined that the service list is included, the DRNC checks the number, n, of MBMS services joined by a UE and sets an index i to 0 in step 920, and determines in step 930 whether i<n. If it is determined that i≧n, the DRNC proceeds to step 980. However, if i<n, the DRNC repeatedly performs steps 940 through 970 on all MBMS services joined by the UE.

That is, the DRNC checks in step 940 whether a non-interest indicator is set for an i^{th} MBMS service included in the service list. If it is determined that the non-interest indicator is set for the i^{th} MBMS service, the DRNC proceeds to step 960 where it adds (attaches) the UE to an MBMS context of the i^{th} MBMS service and excludes the UE from counting for determining a transfer mode of the i^{th} MBMS service.

However, if it is determined that the non-interest indicator is not set for the i^{th} MBMS service, the DRNC adds the UE to the MBMS context of the i^{th} MBMS service and includes the UE in counting for the i^{th} MBMS service in step 950.

After performing steps 930 through 970 on all MBMS services included in the service list, the DRNC performs the existing operation based on the Downlink Signaling Transfer message or Radio Link Setup message in step 980, and ends the operation.

A third embodiment of the present invention indicates whether a UE is uninterested in services currently in progress among one or more MBMS services joined by the UE, or in session of the services, regardless of mobility of the UE.

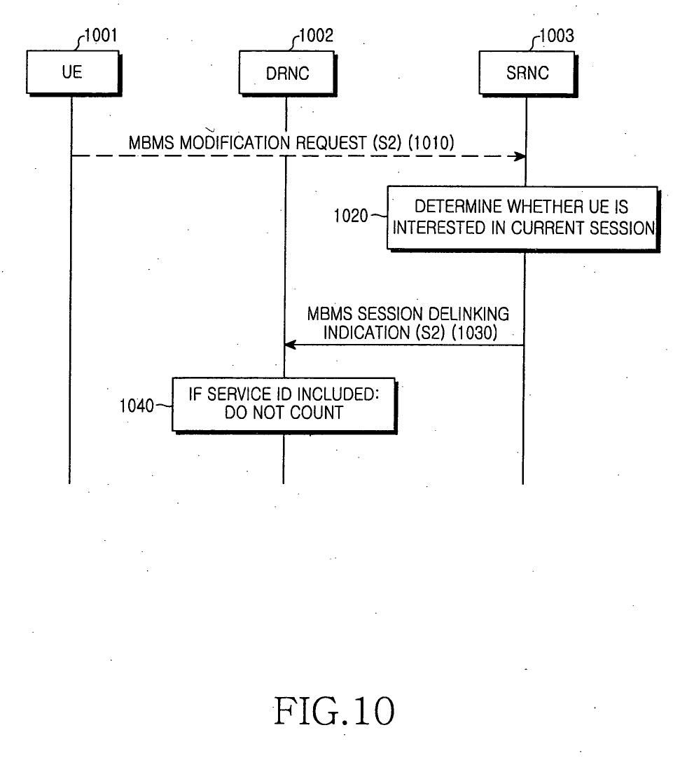

FIG. 10 is a signaling diagram according to a third embodiment of the present invention, in which a UE has joined in MBMS services S1 and S2.

Referring to FIG. 10, an SRNC 1003 receives an MBMS Modification Request message including non-interest indication information for MBMS services from a UE 1001 in step 1010, and checks in step 1020 whether the UE 1001 is interested in a current session of each MBMS service joined by the UE. It is assumed, for example, in FIG. 10 that the UE 1001 is uninterested in the S2.

In step 1030, the SRNC 1003 transmits to a DNRC 1002 an MBMS Session Delinking Indication message with non-interest indication information indicating that the UE 1001 is uninterested in the S2.

Table 3 shows, by way of example, an exemplary format of the MBMS Session Delinking Indication message according to the third embodiment of the present invention.

TABLE 3

| IE/Group | | | IE Type and | Semantics | | Assigned |
|---|---|---|---|---|---|---|
| Name | Presence | Range | Reference | Description | Criticality | Criticality |
| MBMS Bearer | | 0 . . . <maxnoofM | | | GLOBAL | ignore |
| Service List | | BMS> | | | | |
| >TMGI | M | | 9.2.1.80 | | | |
| >Session id | O | | Current | If included, UE | | |
| | | | session id | is uninterested | | |
| | | | | in the session | | |

As shown in Table 3, the MBMS Session Delinking Indication message necessarily includes at least one Temporary MBMS Group Identify (TMGI) which is an MBMS service ID, to provide the DRNC 1002 with an MBMS Bearer Service list which is non-interest indication information for the services that the UE 1001 has joined but not received. In addition, the MBMS Session Delinking Indication message includes a session ID of a current session in the MBMS Bearer Service list to deliver information indicating whether the UE is receiving the current session, for each individual MBMS service.

In step 1040, the DRNC 1002 does not perform counting for including the UE, for the MBMS services included in the MBMS Bearer Service list included in the received MBMS Session Delinking Indication message.

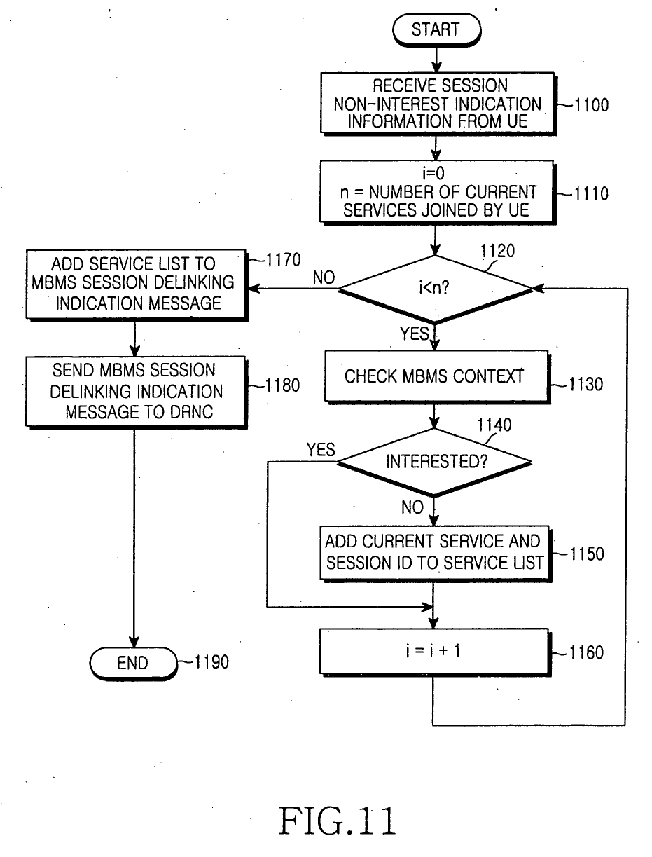

FIG. 11 is a flowchart illustrating an operation of an SRNC according to the third embodiment of the present invention.

Referring to FIG. 11, upon receiving from a UE in step 1100 an MBMS Modification Request message indicating that the UE is uninterested in a current session of a particular MBMS service, an SRNC checks the number, n, of MBMS services joined by the UE and sets an index i to ‘0’ in step 1110, and then determines in step 1120 whether i<n. If it is determined that i≦n, the SRNC proceeds to step 1170. However, if i<n, the SRNC repeatedly performs steps 1130 through 1160 on all MBMS services joined by the UE.

That is, the SRNC checks an MBMS context for an i^{th} MBMS service in step 1130, and determines in step 1140 whether the UE is interested in the i^{th} MBMS service. If it is determined that the UE is uninterested in the i^{th} MBMS service, the SRNC includes a service ID and a session ID of the i^{th} MBMS service in an MBMS Bearer Service list in step 1150, and increases the index i by 1 in step 1160, and then returns to step 1120. However, if the UE is interested in the i^{th} MBMS service, the SRNC jumps to step 1160.

After determining whether the UE is interested in all MBMS services currently in progress, the SRNC includes the MBMS Bearer Service list in an MBMS Session Delinking Indication message in step 1170, and transmits the MBMS Session Delinking Indication message to the DRNC in step 1180.

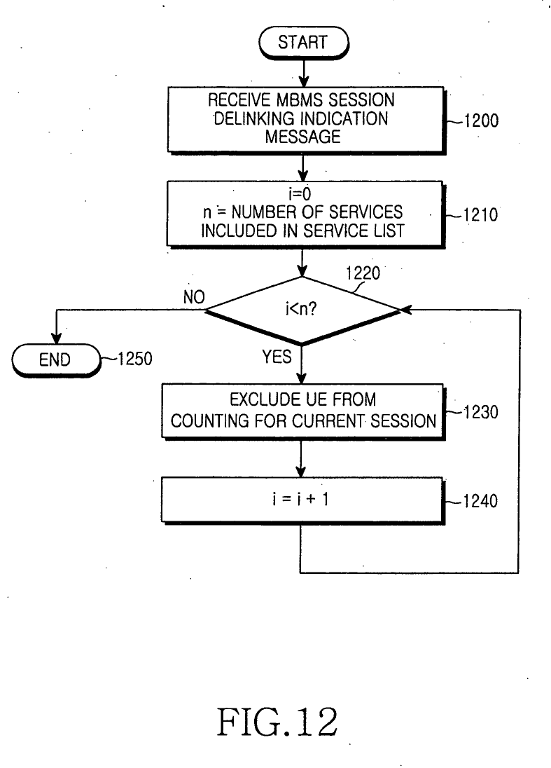

FIG. 12 is a flowchart illustrating an operation of a DRNC according to the third embodiment of the present invention.

Referring to FIG. 12, a DRNC receives an MBMS Session Delinking Indication message with an MBMS Bearer Service list for a particular UE from an SRNC in step 1200. In step 1210, the DRNC checks the number, n, of MBMS services included in the MBMS Bearer Service list and sets an index i to ‘0’. The DRNC determines in step 1220 whether i<n. If it is determined that i≧n, the DRNC ends the operation at step 1250. However, if it is determined that i<n, the DRNC repeatedly performs steps 1230 and 1240 on all MBMS services joined by the UE. That is, the DRNC excludes the UE from counting for determining a transfer mode of an i^{th} MBMS service included in the MBMS Bearer Service list in step 1230, and increases the index i by 1 in step 1240, and then returns to step 1220.

As can be understood from the foregoing description, when a UE moves to a cell managed by a new RNC, an SRNC determines whether the UE is interested in a session and provides the information to a DRNC. Upon detecting information indicating that the UE is uninterested in the session, the DRNC does not include the UE in counting, thereby increasing efficiency of radio resources. That is, embodiments of the present invention inform the DRNC whether the UE is receiving a session of a current service for the services joined by the UE, regardless of mobility of the UE, thereby increasing efficiency of the radio resources.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for transmitting session non-interest indication information for a Multimedia Broadcast/Multicast Service (MBMS) service of a user equipment (UE) in an MBMS system, the method comprising the steps of:
determining, by a serving radio network controller (SRNC), whether the UE desires to receive a current session for an MBMS service joined by the UE;
transmitting, by the SRNC, session non-interest indication information for the MBMS service of the UE to a drift radio network controller (DRNC) according to the determination result; and
including, by the DRNC, the UE in an MBMS context for the MBMS service and determining whether to exclude the UE from counting for the MBMS service according to the session non-interest indication information of the UE.

2. The method of claim 1, further comprising the step of:
receiving, by the SRNC, a cell update request from the UE through the DRNC before determining whether the UE desires to receive a current session for an MBMS service joined by the UE.

3. The method of claim 1, further comprising the step of:
receiving, by the SRNC, the session non-interest indication information for the MBMS service from the UE before determining whether the UE desires to receive a current session for an MBMS service joined by the UE.

4. The method of claim 1, wherein the session non-interest indication information comprises a non-interest indicator indicating that the UE does not desire to receive the current session, and a service identifier (ID) of the MBMS service.

5. The method of claim 4, wherein the transmission step comprises the steps of:
perform no-setting of the non-interest indicator if the UE is receiving the current session for the MBMS service;
perform setting of the non-interest indicator if the UE is not receiving the current session for the MBMS service; and
transmitting the non-interest indicator to the DRNC along with the service ID of the MBMS service.

6. The method of claim 5, wherein the determining step comprises the step of:
excluding the UE from counting for the MBMS service if the non-interest indicator is set; and
including the UE in the counting for the MBMS service if the non-interest indicator is no-set.

7. The method of claim 4, wherein if session transmission timing is substantially inconsistent between a cell where the UE is located before its movement and a cell where the UE is located after its movement, a 1-bit indicator is used as the non-interest indicator.

8. An Multimedia Broadcast/Multicast Service (MBMS) system for providing an MBMS service to a user equipment (UE), comprising:
a serving radio network controller (SRNC) for generating session non-interest indication information of the UE indicating whether the UE desires to receive a current session for the MSMS service joined by the UE; and
a drift radio network controller (DRNC) for receiving the session non-interest indication information of the UE from the SRNC, and determining whether to exclude the UE from counting for the MBMS service according to the session non-interest indication information.

9. The MBMS system of claim 8, wherein the SRNC is configured to generate the session non-interest indication information of the UE upon receiving a cell update request from the UE through the DRNC.

10. The MBMS system of claim 8, wherein the DRNC is configured to determine whether the UE is receiving the current session, based on the session non-interest indication information received from the UE.

11. The MBMS system of claim 8, wherein the session non-interest indication information comprises a non-interest indicator indicating that the UE does not desire to receive the current session, and a service identifier (ID) of the MBMS service.

12. The MBMS system of claim 11, wherein the SRNC is configured to:
perform no-setting of the non-interest indicator if the UE is receiving the current session;
perform setting of the non-interest indicator if the UE is not receiving the current session; and
transmit the non-interest indicator to the DRNC along with the service ID of the MBMS service.

13. The MBMS system of claim 12, wherein the DRNC is configured to:
exclude the UE from counting for the MBMS service if the non-interest indicator is set; and
include the UE in the counting for the MBMS service if the non-interest indicator is no-set.
